(19) United States
(12) Patent Application Publication
(10) Pub. No.: US 2017/0270526 A1
(43) Pub. Date: Sep. 21, 2017

(54) MACHINE LEARNING FOR FRAUD DETECTION

(71) Applicant: HRB Innovations, Inc., Las Vegas, NV (US)

(72) Inventor: William Fitzgerald, Overland Park, KS (US)

(21) Appl. No.: 15/070,138

(22) Filed: Mar. 15, 2016

(51) Int. Cl. G06Q 20/40; G06Q 40/00; G06N 99/00

(52) U.S. Cl. CPC G06Q 20/4016; G06N 99/005; G06Q 40/123

(57) ABSTRACT

System, method and media for detecting fraud in submissions of tax return data. Machine learning techniques including cluster analysis and tree-based classifiers are used to analyze large volumes of previously submitted tax returns based on tax data and submission-related data to detect patterns in genuine and fraudulent returns. These patters are then used to generate rules that can be installed in fraud detection systems in real time to prevent the submission of fraudulent returns. Previous classifications and fraud scores of submitted returns can be updated based on new rules or external indications of fraud.

### RELATED APPLICATIONS

This non-provisional patent application shares certain common subject matter with U.S. patent application Ser. No. ______, filed Mar. ______, 2016, and entitled “TAXPAYER IDENTITY DETERMINATION THROUGH EXTERNAL VERIFICATION,” The above-identified application is hereby incorporated by reference in its entirety into the present application.

### BACKGROUND

### 1. Field

Embodiments of the invention generally relate to detection of fraud in large data sets and, more particularly, to the automated detection of fraudulently submitted tax returns.

### 2. Related Art

Traditionally, systems for fraud detection and fraud scoring rely on analysts to examine instances of fraud and manually construct and install new rules to detect similar frauds in the future. In addition to requiring a large amount of analyst time, this method is slow to update in response to new fraud patterns and analysts may miss complex or subtle fraud patterns that would allow for higher fraud detection rates. Accordingly, a fraud-detection system is needed which can automatically and in real time detect new fraud patterns and generate new rules to catch instances thereof.

### SUMMARY

Embodiments of the invention address the above need by using advanced machine-learning techniques to classify submissions of tax return data as genuine or fraudulent. In particular, in a first embodiment, the invention includes a system for classifying submissions of tax return data as fraudulent, comprising a data store storing a plurality of submissions of tax return data, each submission of tax return data comprising values for a plurality of tax data variables and a plurality of submission data variables, wherein each submission of tax return data has been classified as genuine or fraudulent, a rule-generation engine programmed to automatically generate a plurality of classification rules, wherein each classification rule generates an intermediate fraud score for a submission of tax data being classified based on at least one of a value for a tax data variable associated with the submission of tax data being classified and a value for a submission data variable associated with the submission of tax data being classified, and a classifier, programmed to assign a final fraud score to a newly received submission of tax data by applying at least a portion of the plurality of rules to the plurality of tax data items associated with the newly received submission of tax data and the plurality of submission data items associated with the newly received submission of tax data.

In a second embodiment, the invention includes a method of classifying a tax return as genuine or fraudulent, comprising the steps of ingesting a first submission of tax data comprising first values for a plurality of tax data variables and a plurality of submission data variables, applying a rule of a plurality of rules to calculate a fraud score for the first submission of tax data based on at least a portion of the first values for the plurality of tax data variables and the plurality of submission data variables, classifying the first submission of tax data based on the fraud score for the first submission of tax data, automatically generating a plurality of updated rules for classifying submissions of tax data based on a plurality of submissions of tax data, wherein the plurality of submissions of tax data includes the first submission of tax data, ingesting a second submission of tax data comprising second values for the plurality of tax data variables and the plurality of submission data variables, applying an updated rule of the plurality of updated rules to calculate a fraud score for the second submission of tax data based on at least a portion of the second values for the plurality of tax data variables and the plurality of submission data variables, and classifying the second submission of tax data based on the fraud score for the second submission of tax data.

In a third embodiment, the invention includes one or more computer-readable media storing computer-executable code which, when executed by a processor, performs a method of operating a rules-generation engine, comprising the steps of ingesting values of tax data variables and values of submission data variables for a plurality of submissions of tax return data, ingesting a fraud classification for each submission of tax return data, wherein each fraud classification was calculated using a plurality of classification rules generated by the rules-generation engine, and applying machine-learning techniques to generate a plurality of updated classification rules based on the plurality of submissions of tax data and the corresponding plurality of fraud classifications, wherein the plurality of updated classification rules are programmed to generate a fraud score for a submission of tax data being classified based on the values of tax data variables and values of submission data variables associated with the submission of tax data being classified.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the current invention will be apparent from the following detailed description of the embodiments and the accompanying drawing figures.

### BRIEF DESCRIPTION OF THE DRAWING FIGURES

Embodiments of the invention are described in detail below with reference to the attached drawing figures, wherein:

FIG. 1 depicts an exemplary hardware platform for certain embodiments of the invention;

FIG. 2 depicts an exemplary system in accordance with embodiments of the invention; and

FIG. 3 depicts a flowchart depicting a method in accordance with embodiments of the invention.

The drawing figures do not limit the invention to the specific embodiments disclosed and described herein. The drawings are not necessarily to scale, emphasis instead being placed upon clearly illustrating the principles of the invention.

### DETAILED DESCRIPTION

At a high level, embodiments of the invention monitor submissions of tax data in real time to detect patterns of fraud. Previous systems for fraud detection and fraud scoring rely on analysts to examine returns found to be fraudulent and manually construct and install new rules to detect submissions of similar fraudulent returns in the future. In addition to requiring a large amount of analyst time, this method is slow to update in response to new fraud patterns and analysts may miss some subtle or complex fraud patterns that would allow for higher fraud detection rates. By using machine learning techniques to analyze rejected or otherwise suspicious returns in real time, better fraud detection rules can be installed and updated continuously.

To effectuate such techniques, feedback within the fraud detection system is used to detect new patterns, formulate fraud-detection rules, and install them based on submissions of tax data newly determined to be fraudulent. For example, if a governmental taxation authority indicates that a series of submissions is fraudulent, the submissions (including both the tax return and the metadata associated with the submission) can be passed to a rule-generation engine to identify features common to these returns but rare or nonexistent in genuine tax returns. For example, it may be the case that the fraudulent returns all have an adjusted gross income of $41,000 to $42,200 and a withholding rate of 31.5%. The rule-generation engine, detecting this, can generate a new rule that increases the fraud score for a return matching this pattern. Future submissions of tax data that satisfy this rule will be judged more likely to be fraudulent and accordingly subject to further scrutiny or rejected entirely.

The subject matter of embodiments of the invention is described in detail below to meet statutory requirements; however, the description itself is not intended to limit the scope of claims. Rather, the claimed subject matter might be embodied in other ways to include different steps or combinations of steps similar to the ones described in this document, in conjunction with other present or future technologies. Minor variations from the description below will be obvious to one skilled in the art, and are intended to be captured within the scope of the claimed invention. Terms should not be interpreted as implying any particular ordering of various steps described unless the order of individual steps is explicitly described.

The following detailed description of embodiments of the invention references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the invention. The following detailed description is, therefore, not to be taken in a limiting sense. The scope of embodiments of the invention is defined only by the appended claims, along with the full scope of equivalents to which such claims are entitled.

In this description, references to “one embodiment,” “an embodiment,” or “embodiments” mean that the feature or features being referred to are included in at least one embodiment of the technology. Separate reference to “one embodiment” “an embodiment”, or “embodiments” in this description do not necessarily refer to the same embodiment and are also not mutually exclusive unless so stated and/or except as will be readily apparent to those skilled in the art from the description. For example, a feature, structure, or act described in one embodiment may also be included in other embodiments, but is not necessarily included. Thus, the technology can include a variety of combinations and/or integrations of the embodiments described herein.

### Operational Environment for Embodiments of the Invention

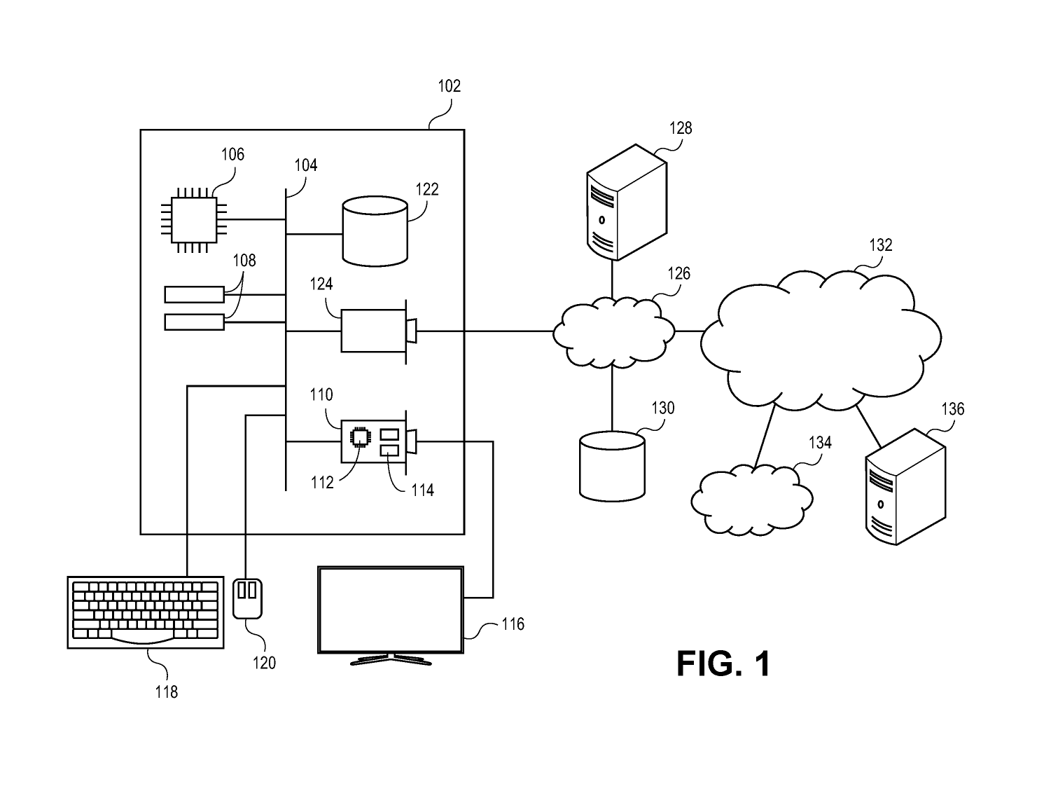

Turning first to FIG. 1, an exemplary hardware platform for certain embodiments of the invention is depicted. Computer 102 can be a desktop computer, a laptop computer, a server computer, a mobile device such as a smartphone or tablet, or any other form factor of general- or special-purpose computing device. Depicted with computer 102 are several components, for illustrative purposes. In some embodiments, certain components may be arranged differently or absent. Additional components may also be present. Included in computer 102 is system bus 104, whereby other components of computer 102 can communicate with each other. In certain embodiments, there may be multiple busses or components may communicate with each other directly. Connected to system bus 104 is central processing unit (CPU) 106. Also attached to system bus 104 are one or more random-access memory (RAM) modules. Also attached to system bus 104 is graphics card 110. In some embodiments, graphics card 104 may not be a physically separate card, but rather may be integrated into the motherboard or the CPU 106. In some embodiments, graphics card 110 has a separate graphics-processing unit (GPU) 112, which can be used for graphics processing or for general purpose computing (GPGPU). Also on graphics card 110 is GPU memory 114. Connected (directly or indirectly) to graphics card 110 is display 116 for user interaction. In some embodiments no display is present, while in others it is integrated into computer 102. Similarly, peripherals such as keyboard 118 and mouse 120 are connected to system bus 104. Like display 116, these peripherals may be integrated into computer 102 or absent. Also connected to system bus 104 is local storage 122, which may be any form of computer-readable media, and may be internally installed in computer 102 or externally and removeably attached.

Computer-readable media include both volatile and nonvolatile media, removable and nonremovable media, and contemplate media readable by a database. For example, computer-readable media include (but are not limited to) RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These technologies can store data temporarily or permanently. However, unless explicitly specified otherwise, the term “computer-readable media” should not be construed to include physical, but transitory, forms of signal transmission such as radio broadcasts, electrical signals through a wire, or light pulses through a fiber-optic cable. Examples of stored information include computer-usable instructions, data structures, program modules, and other data representations.

Finally, network interface card (NIC) 124 is also attached to system bus 104 and allows computer 102 to communicate over a network such as network 126. NIC 124 can be any form of network interface known in the art, such as Ethernet, ATM, fiber, Bluetooth, or Wi-Fi (i.e., the IEEE 802.11 family of standards). NIC 124 connects computer 102 to local network 126, which may also include one or more other computers, such as computer 128, and network storage, such as data store 130. Generally, a data store such as data store 130 may be any repository from which information can be stored and retrieved as needed. Examples of data stores include relational or object oriented databases, spreadsheets, file systems, flat files, directory services such as LDAP and Active Directory, or email storage systems. A data store may be accessible via a complex API (such as, for example, Structured Query Language), a simple API providing only read, write and seek operations, or any level of complexity in between. Some data stores may additionally provide management functions for data sets stored therein such as backup or versioning. Data stores can be local to a single computer such as computer 128, accessible on a local network such as local network 126, or remotely accessible over Internet 132. Local network 126 is in turn connected to Internet 132, which connects many networks such as local network 126, remote network 134 or directly attached computers such as computer 136. In some embodiments, computer 102 can itself be directly connected to Internet 132.

### Operation of Embodiments of the Invention

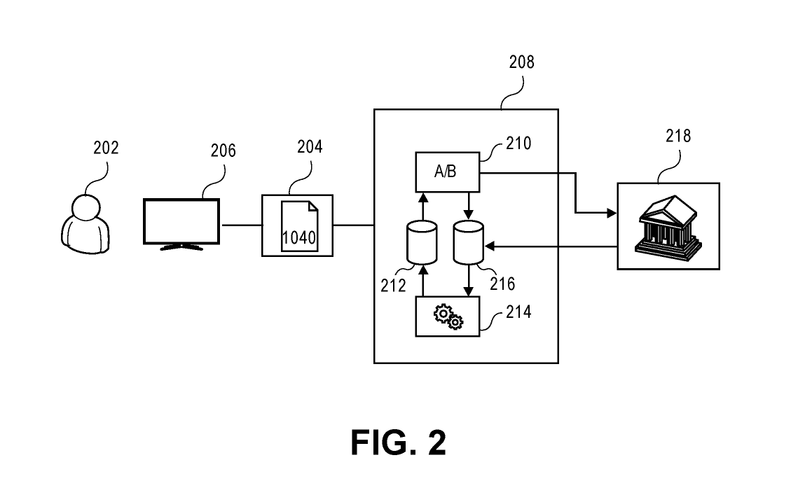

Turning now to FIG. 2, an exemplary system in accordance with embodiments of the invention is depicted and referred to generally by reference numeral 200. As in a conventional tax return preparation system, user 202 provides information to tax preparation system 204 in the process of preparing a tax return for filing with one or more government taxing authorities. User interface engine 206 provides a front end into system 204 for user 202 to enter the tax-related information (referred to herein as tax data) needed to prepare the return. Information input by the user includes information identifying the taxpayer for the return. It should be appreciated that the tax information discussed herein relates to a particular taxpayer, although a user of the invention may be the taxpayer or an authorized third party operating on behalf of the taxpayer, such as a professional tax preparer (“tax professional”) or an authorized agent of the taxpayer. Therefore, use of the term “taxpayer” herein is intended to encompass either or both of the taxpayer and any third party operating on behalf of the taxpayer. Additionally, a taxpayer may comprise an individual filing singly, a couple filing jointly, a business, or a self-employed filer. It is also a goal of system 204 to ensure that user 202 is actually the taxpayer whose identifying information they have provided, in order to avoid fraudulent returns and, as such, interface engine 206 and tax preparation system 204 gather additional information ancillary to the return-preparation process that is useful for detecting fraud, referred to herein as “submission data.” For example, a unique machine identifier of the computer 102 used by user 202 to complete the return is an example of submission data, as is the age of the account on tax preparation system 204 used to prepare the return and the bank to which a refund (or from which a payment) is directed. Other examples of submission data are discussed in greater detail below.

Some information may be manually input by user 202 into user interface engine 206, some information may be pre-populated based on previous returns prepared for the taxpayer by system 204, and some information may be able to be imported directly from a provider using credentials entered by user 202. User interface engine 206 can prompt user 202 to enter such credentials in order to simplify the task of manually entering the data on the tax form. User interface engine 206 can also simplify the process of completing the tax return itself, by converting tax forms into a more user-friendly questionnaire, suggesting deductions and credits, etc. Such a front end is presently offered in multiple forms by H&R Block®. For example, front end 206 may be a web site that user 202 can log into using a web browser, or it may take the form of dedicated software running on the user's computer (such as, e.g., computer 102) or the computer of a tax professional preparing the tax return for user 202. Once all of the tax data has been input (or imported) into tax preparation system, the tax return can be prepared as is known in the art and all the tax and submission data passed to fraud detection system 208.

It is a goal of fraud detection system 208 to classify returns as genuine or fraudulent. A fraudulent return may, for example, be one where a malefactor impersonates a taxpayer who has not yet prepared their return, supplying false but plausible tax data to obtain a tax refund, which is then liquidated before the actual taxpayer knows that their identity has been stolen. As such, it is desirable to identify such fraudulent returns prior to their submission to a governmental taxation authority. Prior systems for fraud detection based on tax data and submission data identify fraudulent submissions via static, manually updated rules. For example, it may be the case that an analyst examining returns flagged as fraudulent notices that an unusually high proportion of tax returns with refunds directed to a particular bank are ultimately determined to be fraudulent (either by the governmental taxation authority or by other fraud detection methods). In such a case, the analyst may add a new static rule that flags returns with refunds directed to that bank for additional scrutiny.

However, this approach is slow and fundamentally reactive. By the time an analyst notices a large number of rejected returns, many taxpayers have already had their identities stolen. Furthermore, fraudulent returns must be identified as fraudulent before they can be used as the basis for a rule. Accordingly, embodiments of the invention utilize advanced machine-learning techniques (as discussed in greater detail below) to learn to distinguish between “normal” (i.e. genuine) and “aberrant” (likely to be fraudulent returns) in real time so that new fraud-detection rules can be created and installed without the need for a human in the loop.

In particular, fraud detection system 208 comprises classifier 210, rules data store 212, rules generation engine 214, and tax return submission data store 216. As depicted in FIG. 2, these components are interconnected in such a way that they provide feedback to successively refine the fraud detection process as additional returns are prepared and accepted or rejected by the governmental taxation authority. Although a new submission of tax return data passed first to classifier 210, it is illustrative to consider first tax return submission data store 216.

Tax return submission data store 216 stores, for each submission of tax return data, tax data for that tax return submission, submission data for that tax return submission, and a fraud score or fraud classification for that tax return. As discussed above, tax data for a tax return submission is that information needed to complete the tax return. Tax data may be provided by user 202, imported from a prior tax return for the taxpayer, or imported from an external source (e.g., a bank or a payroll provider) based on data provided by user 202. Tax data may also include values derived from other tax data. For example, the taxpayer's Adjusted Gross Income (AGI) is a tax data item. The taxpayer's AGI is not entered directly by user 202, but calculated as the taxpayer's gross income minus the above-the-line deduction. The taxpayer's gross income and above-the-line deduction are themselves calculated values based on other calculated values and values directly provided (or imported) by user 202. Table 1 contains an exemplary list of tax data items.

TABLE 1

Bank for Refund
Bank Account for Refund
Taxpayer and Spouse Name
Taxpayer and Spouse Social Security Number
Taxpayer Mailing Address
Taxpayer Filing Status
Taxpayer Date of Birth
Taxpayer Phone Number
Adjusted Gross Income
Earned Income Credit Claimed
Number of W-2s
Refund Amount
State Returns Filed
Filing Date and Time

Submission data for a tax return is information associated with the submission of the return itself, and which may not be used in actually competing the tax return. For example, the IP address of the computer 102 used to complete the return is submission data. Similarly, the email address associated with the account used in preparing the return is submission data. In some embodiments, data may be both submission data and tax data. For example, the user may provide a name when creating a tax preparation account (submission data). This name may then be reused or reentered when preparing the return (tax data). Table 2 contains an exemplary list of submission data items, together with an exemplary effect on the fraud score associated with the submission (where a positive effect represents a decreased likelihood of fraud).

TABLE 2

| Submission Data Item | Exemplary Effect on Fraud Score |
|---|---|
| Submitting Machine ID | Positive if associated with taxpayer |
| | Negative if associated with known fraud |
| Submitting Machine IP | Negative if proxy IP from high risk area |
| Address | Negative if associated with anonymous |
| | IP service such as TOR |
| Submitting Machine Location | Positive or negative based on taxpayer |
| (IP Geolocation or Reported | location vs. reported location |
| Mobile Location) | |
| Account Age When | Positive for older accounts |
| Submitting | |
| Acceptance Rate for Returns | Positive for higher acceptance rates |
| Submitted by Account | |
| Account Username | Positive if matches taxpayer name |
| | Negative if matches pattern of |
| | fraudulent usernames |
| Account Creation Time | Negative if many accounts created in |
| | close succession |
| Account Modification Time | Negative if modified immediately prior to |
| | submission |
| Account Email Address Local | Negative if matches pattern of |
| Part | fraudulent usernames |
| Account Email Provider | Negative if high-risk free email provider |
| Account Email Activity | Negative if known suspicious email |
| | activity |
| Taxpayer and Spouse Name | Positive if matches prior tax returns |
| Submission Time | Positive if during normal business hours |
| Bank for Payment | Negative if high rate of fraudulent |
| | accounts |
| Age of Bank Account for | Positive for older accounts |
| Payment | Positive for prior use of account by |
| | taxpayer |
| Status of Bank Account for | Positive if account open |
| Payment | Negative if account closed |
| Name on Bank Account for | Positive if matches taxpayer |
| Payment | |
| Fraud Marker on Bank | Negative |
| Account for Payment | |
| Fee for Tax Preparation | Negative if free level of tax preparation |
| | used |
| Fee for Refund Vehicle | Negative if fee deducted from refund |
| Promotional Code Used | Positive if single-use code |
| | Negative if commonly used code |
| Browser Session Identifier | Negative if associated with prior |
| | fraudulent submissions |
| Refund Type | Positive if deposited in trackable bank |
| | account |
| | Negative if loaded onto prepaid card |
| Taxpayer Phone Number | Positive if matches prior taxpayer phone |
| | number |
| State Returns Completed | Positive if matches taxpayer known |
| | state of residence |
| | Negative if matches high-fraud states |

Of course it will be appreciated that many hundreds or even thousands of tax data variables and submission data variables may be present and that those present on Tables 1 and 2 are merely exemplary and non-limiting. In some embodiments, the tax data and submission data items are more or less granular than the examples given in Tables 1 and 2. For example, Taxpayer Address may be instead broken down into Taxpayer House Number, Taxpayer Street, Taxpayer City, Taxpayer State, and Taxpayer Zip Code. Similarly, Account Email Address Local Part and Account Email Provider may be combined into Account Email Address. As stored in tax return submission data store 216, each of the listed tax data items may be stored as a variable for which each submission of tax return data has a corresponding value. For example, if tax return submission data store 216 is stored in tabular format, the tax and submission data items are columns and each tax return submission is a row with values in each column.

Each submission of tax return data may further be associated with a fraud score or fraud classification. In some embodiments, the fraud score is a simple binary value (i.e., the return is either determined to be genuine or fraudulent). In other embodiments, the fraud score can take on a range of values, and returns are classified as genuine or fraudulent based on whether their associated fraud score exceeds a predetermined threshold. Other methods of fraud scoring, as discussed below with respect to rules generation engine 214 and rules data store 212, are also contemplated. In some embodiments, when governmental taxation authority 218 indicates a return to be fraudulent, the fraud score for that return in tax return submission data store 216 is adjusted accordingly.

Rules generation engine 214 processes the returns stored in tax return submission data store 216 to generate classification rules for later use by classifier 210 based on the values of the tax data item and submission data item variables for returns scored as fraudulent or genuine. A person of skill in the art will appreciate that such a calculation, particularly on a large data set, is only possible with the aid of computer-assisted machine-learning algorithms and techniques such as multivariate analysis and/or cluster analysis. In some embodiments, big-data techniques including generalized linear modeling and k-means clustering can be used to generate rules. In other embodiments, tree-based algorithms such as gradient-boosting machines can be used. One of skill in the art will appreciate that a variety of machine learning techniques can be used alone or in combination to generate classification rules. Rules generation engine 214 automatically infers these rules based on the large volume of submission data stored in submission data store 216. In particular and in one embodiment, a cluster analysis technique such as density-based clustering can be employed.

In general, cluster analysis is the study of how to group a set of objects in such a way that similar objects are placed in the same group. These categories need not be known a priori, or even have any semantic meaning associated with them. Here, the objects are the completed tax returns stored in submission data store 216 and the resulting clusters of returns share certain properties that may indicate whether returns are genuine or fraudulent. Density-based clustering defines clusters to be areas of higher density in a higher-dimension space representing the various features of the objects. Thus, clusters in this application will contain tax returns that share many similar features. As such, the values for the variables used in creating a new rule will be similar among returns in a cluster. If a high fraction of the returns in a cluster are fraudulent, then the rule will tend to increase the fraud score for a return satisfying the rule. If a low fraction of the rules in a cluster are fraudulent, then the rule corresponding to the cluster will tend to reduce the fraud score for rules satisfying the rule.

In another embodiment, a different technique performed by rules generation engine 214 for creating rules is biclustering. Biclustering allows the simultaneous clustering of the dependent and independent variables of a data set. In this way, a set of dependent variables (multiple components of a higher-dimensional fraud score) that exhibit similar behavior across a set of independent variables (here, for example, the tax data items and submission data items) can be identified, and vice versa. These biclusters can then be used to predict whether the submission is fraudulent based on all tax data variable values and submission data variable values.

Other techniques can also be used by rules generation engine to create fraud detection rules based on tax data variables and submission data variables and combinations of variables. For example, rules empirically determined by analysts can be used to supplement rules data store. Additionally, it will be appreciated that, as additional tax returns are added to submission data store 216, the set of rules can be refined by re-analyzing the larger data set to improve accuracy. Accordingly, rules generation engine 214 may regularly re-calculate rules based on the most current data.

Based on the output of rules generation engine 214, rules data store is populated with one or more rules for determining a fraud score for a given tax return. For example, one rule might classify a return as fraudulent if the Submission Machine ID has been used for at least five returns, at least 20% of which have been rejected by the government taxation authority, with accounts creation times between 1 am and 3 am and returns filed less than 1 hour from account creation. Another rule might increase a submissions fraud score if the associated email address matches a pattern (e.g., user1@gmail.com, user2@gmail.com, and so on) that has been seen in at least fifteen other returns. As described above, these rules may be periodically recalculated by rules generation engine 214. In some embodiments, all rules are removed and regenerated when rules generation engine 214 updates rules data store 212. In other embodiments, new rules are added to supplement rules data store 212 whenever they are generated (i.e., whenever new patterns of fraudulent returns are detected). In some embodiments, rules data store 212 is seeded with empirically determined rules. In some such embodiments, these rules are retained even when automatically generated rules are refreshed. In other embodiments, these rules are used to make initial classifications but can be updated or replaced by rules generation engine 214.

Once rules data store 212 has been populated appropriately with rules, classifier 210 can apply them to a tax return submission. Classifier 210 broadly determines whether a return is fraudulent based on the associated values for tax data variables and submission data variables. Regardless of the statistical analysis technique used by rules generation engine 214, classifier 210 may assign each return to soft clusters, representing a likelihood that the return belongs to a given cluster. If the likelihood that a return falls into a particular cluster is above a given threshold, then the corresponding fraud score adjustment can be applied to that return. In some embodiments, this implies that at most one rule will apply to a given return. In other embodiments, the threshold is such that a plurality of clusters have likelihoods that fall above the threshold for the return, and as such, the return will satisfy a plurality of rules and a plurality of adjustments to the fraud score will be applied to the return. As such, the threshold for assigning a prototype to a return becomes a parameter that can be used to adjust the trade-off between accurately classifying a return and over-fitting the data.

Classifier 210 begins by ingesting the tax data items and submission data items for the return and converting them to values for the appropriate tax data variables and submission data variables the are used in the rules stored in rules data store 212. One or more rules from rules data store 212 can then be applied to the return being classified. For example, rules may be applied in order of accuracy until a rule matches. In other embodiments, rules may be applied to a return until the confidence exceeds a threshold. In still other embodiments, all rules may be applied to each return, adjusting the fraud score accordingly each time a rule matches.

Once all appropriate rules have been applied, classifier 210 classifies the return being submitted as genuine or fraudulent. In those embodiments where a classification for a return is a binary value, the applied rules can be appropriately aggregated (e.g., using an appropriate Boolean function) to return the final classification. For those embodiments where a classification score within a range is generated, the final fraud score can be compared to an appropriate threshold to classify the submitted return as genuine or fraudulent. In some embodiments, only those returns classified as genuine are submitted to governmental taxation authority 218. In other embodiments, all returns are submitted, and fraudulent returns are flagged for further review by governmental taxation authority 218. In still other embodiments, all returns are submitted, but those returns classified as fraudulent are prohibited from receiving any form of advance against an anticipated tax return. In yet other embodiments, returns falling below a first threshold are submitted and permitted advances against anticipated returns, returns falling above the first fraud threshold but below a second fraud threshold are submitted but not permitted advances against returns, and returns falling above the second threshold are not submitted to governmental taxation authority 218.

In some embodiments, returns classified as suspicious (or fraudulent) may be subject to additional verification. For example, users submitting such returns may be subject to additional, third-party verification via out-of-wallet questions, knowledge-based authentication, or other techniques. In other embodiments, all users may be subject to third-party authentication when creating an account on the return-preparation system or as part of the initial enrollment process. Third-party identity verification and authentication is discussed in greater detail in concurrently-filed U.S. patent application Ser. No. ______, titled “TAXPAYER IDENTITY DETERMINATION THROUGH EXTERNAL VERIFICATION” and incorporated by reference above. Table 3 below provides exemplary methods of additional verification.

TABLE 3

Facial recognition (e.g., submitted via phone camera)
Fingerprint recognition (e.g., using phone app)
Retina Scan (e.g., onsite)
Identity Score based on third-party matching criteria
Knowledge-based authentication
Out-of-wallet questions

In any embodiment where third-party authentication is used, it provides two sources of additional data: first, the third-party authentication profile itself (i.e., the questions and answers provided by the user) and second, whether the user successfully passes the third-party authentication process. The former set of information can be used as a third class of data variables by rules generation engine 214. Such data variables are referred to as “authentication data variables” herein.

The latter set of information can be used to “close the loop” on any tax return which is subject to the third-party authentication process. Thus, for example, if the return is initially classified as fraudulent but the user successfully completes the third-party identity verification process, then the fraud classification (or fraud score) of the corresponding submission in tax return submission data store 216 can be updated accordingly. Conversely, if a user fails the third-party identity verification process, then the fraud score of the application can be modified to reflect the increased likelihood of fraud associated with the data values in the return.

Similarly, governmental taxation authority 218 may in some cases return submitted returns as fraudulent that were initially classified as genuine by classifier 210. In such cases, the fraud classification (or fraud score) of the corresponding submission in tax return submission data store 216 can be updated accordingly. In some embodiments, this may cause rule generation engine 214 to regenerate the current set of rules based on the updated classification.

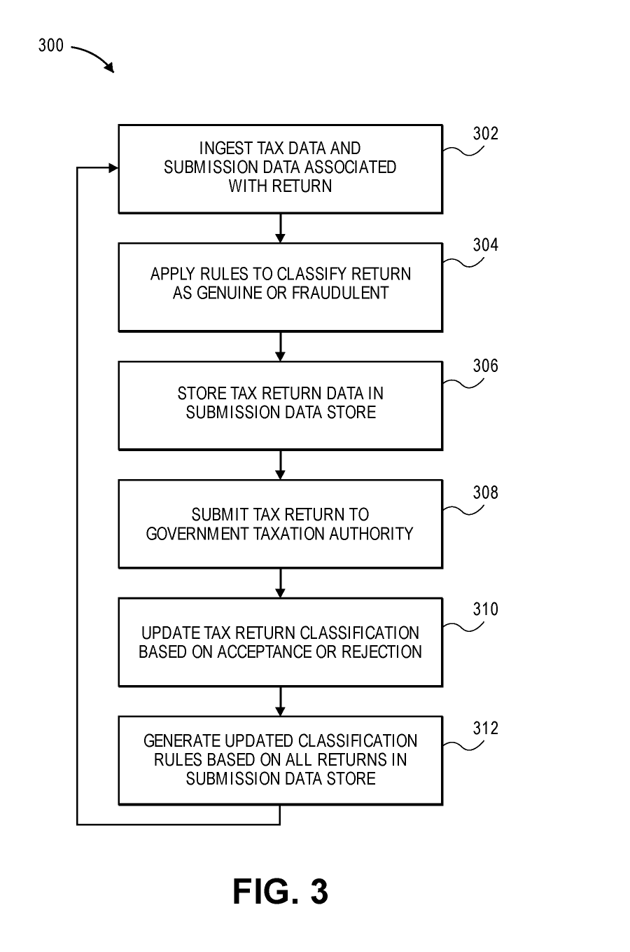

Turning now to FIG. 3, a flowchart depicting a method in accordance with embodiments of the invention is depicted and referred to generally by reference numeral 300. Initially, at a step 302, data corresponding to a return to be classified is ingested at step 302. As discussed above, the data for the return to be classified will broadly include both tax data and submission data. In some embodiments, ingesting data includes converting it to a format usable by classifier 210 or rules generation engine 214. For example, continuous data may be made binary by the appropriate use of thresholds, floating-point or fixed-point data may be converted into integer data by rounding, truncation, or scaling, and ranged data may be normalized appropriately. As discussed above data may be broken apart into finer-grained variables (e.g., the taxpayer's address broken down into house number, street, city, state, and zip code) or combined as needed.

Next, at step 304, appropriate rules are applied to the ingested tax data and submission data for the return being classified. As discussed above, various embodiments may apply rules differently. For example, certain embodiments may apply a single rule to first assign a given return to a cluster and then determine whether the return is fraudulent based on that cluster. Other embodiments may start by assuming that a return is genuine and then changing its classification to fraudulent if it meets at least one of a disjunctive series of rules. Still other embodiments may apply all rules in rule data store 212, with each rule adjusting an incremental fraud score until all rules have been applied and the final fraud score is determined. Yet other embodiments may begin with the fraud score at zero (or other intermediate value) and apply rules in series until the fraud score exceeds either a threshold for being classified genuine in one direction or a threshold for being classified as fraudulent in the opposite direction.

Once the return has been classified as genuine or fraudulent, the tax data and submission data corresponding to the return are stored in tax return submission data store 216 for subsequent analysis, along with the calculated fraud score. Those embodiments that calculate a fraud score within a range and then threshold that range to determine a final classification may store the fraud score in tax return submission data store 216 for finer-grained results. In some embodiments, tax data and submission data may be stored in separate data stores. In some embodiments, rules generation engine 214 may update or recalculate rules whenever new tax returns are stored in tax return submission data store 216.

Next, at step 308, the tax data, in the form of a completed tax return, is submitted to governmental taxation authority 218. As discussed above, in some embodiments, the tax data may only be submitted if the tax return submission is classified as genuine or if the fraud score is below a predetermined threshold. In some embodiments, fraudulent tax returns are submitted to governmental taxation authority 218 with an indication that they are believed to be fraudulent. In other embodiments, fraudulent returns are instead or in addition submitted to a common pool of such fraudulent returns shared among tax preparation service providers to allow statistical analysis of fraudulent returns. In some such embodiments, tax return submission data store 216 is supplemented with appropriately classified fraudulent returns from other tax preparation service providers.

Next, at step 310, the return is accepted or rejected by governmental taxation authority 218. This acceptance or rejection may occur immediately after submission, after some delay after the return is submitted to the governmental taxation authority 218, or after a previous acceptance or rejection of the return. For example, a return previously accepted may be rejected if the taxpayer identified in that return alerts governmental taxation authority 218 that they did not authorize the submission of that return. Alternatively, a previously rejected return may be accepted if the taxpayer provides additional verification that the submitted return is, in fact, genuine. When a return is accepted or rejected, this may cause the classification in tax return submission data store 216 to be updated. For example, if a return initially classified as genuine is subsequently rejected, the classification may be updated to reflect this. In those embodiments where a fraud score within a range is stored with the classification, the fraud score may be set to the extreme value of the status of the return is altered by governmental taxation authority 218 to reflect the increased confidence in the new classification.

Finally, at step 312, rules generation engine 214 updates the rules stored in rules data store 212 based at least in part on the newly added tax return submission and/or the newly updated classification. For example, if a number of return submissions have been added to rules data store 212 that have concentrated and sequential values for the Taxpayer Date-of-Birth tax data variable, this may cause a new cluster to be detected by rules generation engine 214. If a number of returns in this cluster are classified as fraudulent, a rule for classifying other returns in the cluster as fraudulent may be generated. In some embodiments, a new cluster may be determined to be aberrant and classified as fraudulent even if none of the individual returns in it were previously classified as fraudulent. In this way, new patterns of fraud can be preemptively detected before they can impact taxpayers. Once the rules in rules data store 212 have been updated to reflect the newly classified submission of tax return data in tax return submission data store 216, processing can return to step 302 to classify additional tax returns based on the newly updated rules.

Many different arrangements of the various components depicted, as well as components not shown, are possible without departing from the scope of the claims below. Embodiments of the invention have been described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims. Although the invention has been described with reference to the embodiments illustrated in the attached drawing figures, it is noted that equivalents may be employed and substitutions made herein without departing from the scope of the invention as recited in the claims.

Having thus described various embodiments of the invention, what is claimed as new and desired to be protected by Letters Patent includes the following:

1. A system for classifying submissions of tax return data as fraudulent or genuine, comprising:
a data store storing a plurality of submissions of tax return data, each submission of tax return data comprising values for a plurality of tax data variables and a plurality of submission data variables,
wherein each submission of tax return data has been classified as genuine or fraudulent;
a rule-generation engine programmed to automatically generate a plurality of classification rules,
wherein each classification rule generates an intermediate fraud score for a submission of tax data being classified, said intermediate fraud score based on at least one of a value for a tax data variable associated with the submission of tax data being classified and a value for a submission data variable associated with the submission of tax data being classified;
a classifier, programmed to assign a final fraud score to a newly received submission of tax data by applying at least a portion of the plurality of classification rules to the plurality of tax data items associated with the newly received submission of tax data and the plurality of submission data items associated with the newly received submission of tax data; and
a tax return preparation system, programmed to prepare a tax return based on the newly received submission of tax data and submit the tax return to a governmental taxation authority only if the final fraud score is below a predetermined threshold.

2. The system of claim 1, wherein the rule generation engine is further programmed to be able to generate a plurality of updated classification rules if a classification of a submission of tax return data stored in the data store changes.

3. The system of claim 1, wherein the rule-generation engine automatically generates the plurality of classification rules using a machine learning algorithm.

4. The system of claim 3, wherein the machine learning algorithm is based on cluster analysis.

5. The system of claim 1, wherein the rule-generation engine further automatically installs the plurality of classification rules in the classifier.

6. The system of claim 1, wherein each classification rule of the plurality of classification rules modifies an intermediate fraud score, such that the final fraud score is calculated by starting with a baseline fraud score and using each of the plurality of rules in turn to modify the intermediate fraud score.

7. The system of claim 1, wherein the newly received submission of tax data and the final fraud score are stored in the data store.

8. A method of classifying a tax return as genuine or fraudulent, comprising the steps of:
ingesting a first submission of tax data comprising first values for a plurality of tax data variables and a plurality of submission data variables;
applying a rule of a plurality of rules to calculate a fraud score for the first submission of tax data based on at least a portion of the first values for the plurality of tax data variables and the plurality of submission data variables;
classifying the first submission of tax data based on the fraud score for the first submission of tax data;
automatically generating, based on a plurality of submissions of tax data, a plurality of updated rules for classifying submissions of tax data,
wherein the plurality of submissions of tax data includes the first submission of tax data;
ingesting a second submission of tax data comprising second values for the plurality of tax data variables and the plurality of submission data variables;
applying an updated rule of the plurality of updated rules to calculate a fraud score for the second submission of tax data based on at least a portion of the second values for the plurality of tax data variables and the plurality of submission data variables; and
classifying the second submission of tax data based on the fraud score for the second submission of tax data.

9. The method of claim 8, wherein the plurality of rules are generated using a machine learning algorithm.

10. The method of claim 9, wherein the machine learning algorithm is based on cluster analysis.

11. The method of claim 8, further comprising the steps of
submitting the submission of tax data to a governmental taxation authority if the submission is classified as genuine; and
rejecting the submission of tax data if the submission is classified as fraudulent.

12. The method of claim 8, wherein the fraud score for the first submission is calculated by successively applying each of the plurality of rules.

13. The method of claim 8, wherein the first submission of tax data is classified by comparing the fraud score to a predetermined threshold.

14. The method of claim 8, wherein the plurality of rules are used to calculate respective fraud scores for a plurality of submissions of tax data.

15. One or more computer-readable media storing computer-executable code which, when executed by a processor, performs a method of operating a rules-generation engine, comprising the steps of:
ingesting values of tax data variables and values of submission data variables for a plurality of submissions of tax return data;
ingesting a fraud classification corresponding to each of the plurality of submissions of tax return data, wherein each fraud classification was calculated using a plurality of classification rules generated by the rules-generation engine; and
applying machine learning techniques to generate a plurality of updated classification rules based on the plurality of submissions of tax return data and the corresponding plurality of fraud classifications,
wherein the plurality of updated classification rules are programmed to generate a fraud score for a submission of tax data being classified based on the values of tax data variables and values of submission data variables associated with the submission of tax data being classified.

16. The media of claim 15, wherein the machine learning technique is based on cluster analysis.

17. The media of claim 15, wherein the fraud score is generated by applying each of the plurality updated classification rules in succession until the submission of tax data satisfies one of the plurality of updated classification rules.

18. The media of claim 15, wherein the fraud score is calculated by successively applying each of the plurality of updated classification rules.

19. The media of claim 15, further comprising the steps of:
detecting that at least one fraud classification for one of the plurality of submissions of tax return data has changed; and
in response, applying machine learning techniques to generate a plurality of revised classification rules based on the plurality of submissions of tax data, the corresponding plurality of fraud classifications, and the at least one changed fraud classification.

20. The media of claim 15, wherein each of the plurality of updated classification rules is based on at least one tax data variable and at least one submission data variable.
